(19) United States
(12) Patent Application Publication
(10) Pub. No.: US 2022/0374902 A1
(43) Pub. Date: Nov. 24, 2022

(54) PROVIDING IRREVOCABLE EVIDENCE OF PHYSICAL PRESENCE USING PROXIMITY TECHNOLOGY AND A DISTRIBUTED LEDGER

(71) Applicant: Capital One Services, LLC, McLean, VA (US)

(72) Inventor: Arthur Sabintsev, Pikesville, MD (US)

(21) Appl. No.: 17/323,861

(22) Filed: May 18, 2021

(51) Int. Cl. G06Q 20/40; G06Q 20/32; G06Q 20/38; G06Q 20/36; G06Q 20/06; G06F 16/27; H04L 29/06

(52) U.S. Cl. CPC G06Q 20/4015; G06Q 20/3224; G06Q 20/389; G06Q 20/3676; G06Q 20/3678; G06Q 20/4037; G06Q 20/0655; G06Q 20/4016; G06Q 20/386; G06Q 20/4014; G06F 16/27; H04L 63/083; G06Q 20/326; G06Q 40/02

(57) ABSTRACT

Aspects described herein include using proximity technology such as beacon devices or geofences to detect physical presence at a physical location. Presence information may be generated and included in a non-fungible token (NFT). The NFT may be provided to a digital wallet. The identity of an individual associated with the digital wallet may be authenticated. A distributed ledger may record the transaction that provides the NFT to the digital wallet.

### FIELD OF USE

Aspects of the disclosure relate generally to presence detection and more specifically to using beacons and a distributed ledger to provide irrevocable evidence of physical presence.

### BACKGROUND

Various approaches may be employed to detect an individual's physical presence at a physical location. Authenticating the identity of the detected individual, however, can present a challenge. Face recognition, for example, may be employed to provide a possible identity for an individual detected at a physical location but may not be reliable (e.g., provide low accuracy), may raise privacy concerns, and may be computationally intensive. Access control devices (e.g., keyfobs, key cards, etc.) may be associated with a particular individual, but there is no guarantee that the individual using the access control device is the same individual it is associated with (and not, e.g., an impostor). Further, records indicating the presence of an individual at a physical location may be subject to tampering thereby potentially jeopardizing the value of such records as evidence of the individual's physical presence at a physical location.

Aspects described herein may address these and other problems and may generally improve, among other things, the quality of evidence of a detected physical presence and the security of such evidence by using a distributed ledger to provide tokens having presence information.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Aspects as described herein may include detecting physical presence at a physical location using a mobile computing device and a beacon device located at that physical location. A system may obtain an address of a digital wallet based on the mobile computing device receiving a message from the beacon device. The system may record a transaction block on a distributed ledger. The transaction block may indicate the address of the digital wallet as well as a non-fungible token (NFT). The non-fungible token indicated by the transaction block may include presence information such as an indication of the physical location, an indication of the date the mobile computing device received the message from the beacon device, and an indication of the time the mobile computing device received the message from the beacon device. In this way, evidence of physical presence at a physical location may be preserved using the distributed ledger.

Aspects as described herein may also include detecting unauthorized financial transactions using the evidence of physical presence recorded using a distributed ledger. A system may monitor financial transactions associated with an owner of the digital wallet. The system may determine whether the financial transactions are authorized or unauthorized financial transactions based on the presence information. The system may determine a financial transaction is an authorized financial transaction when the digital wallet includes a non-fungible token with presence information that corresponds to the financial transaction. The system may determine a financial transaction is an unauthorized financial transaction when the digital wallet does not include a non-fungible token with presence information that corresponds to the financial transaction. The system may send the owner of a digital wallet an indication of an unauthorized financial transaction. Other types of transactions may be evaluated in a similar fashion to determine whether those transactions are authorized or unauthorized.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a physical presence detection system in which one or more aspects described herein may be implemented;

FIG. 2 shows an example computing device in accordance with one or more aspects described herein;

FIG. 3 shows a flow chart of an example process for detecting the presence of a mobile computing device at a physical location and recording the detected physical presence on a distributed ledger;

FIG. 4 shows a flow chart of an example process for authenticating an owner of a digital wallet;

FIG. 5 shows a flow chart of an example process for providing evidence of physical presence using a distributed ledger; and

FIG. 6 shows a flow chart of an example process for detecting an unauthorized financial transaction using a distributed ledger.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for using proximity technology (e.g., beacons, geofences) and a distributed ledger to provide irrevocable evidence of physical presence. A beacon device may transmit messages that can be detected by mobile computing devices (e.g., smartphones, tablets, wearable devices, etc.) within wireless range of those beacon devices. A mobile computing device may listen for such messages and, based on detecting a message, initiate an authentication process that identifies the user of the mobile computing device. The authentication process may also be triggered based on the mobile computing device entering or exiting a geofenced area. Having determined the identity of the individual, presence information may be generated that indicates when and where the message from the beacon was detected along with the individual's identity. A location-based service may also provide the presence information based on the location of the geofenced area. This presence information may be recorded in an immutable fashion using a distributed ledger. For example, an NFT may be generated that includes the presence information. The NFT may be provided to a digital wallet associated with the authenticated individual. The distributed ledger may record a transaction block that indicates the NFT was provided to the digital wallet. In this way, the distributed ledger may preserve a record of the individual's physical presence at the physical location. By authenticating the individual, the probative value of the physical presence information as evidence of the individual's presence at the physical location, in other words the quality of the physical presence information, is thereby improved. By using an NFT and a distributed ledger to preserve the physical presence information, the security of that physical presence information is thus also improved. The uniqueness of the NFT and the consensus-based nature of the distributed ledger mitigate the possibility of tampering with the evidence of the individual's presence at the physical location. Physical presence detection systems as described herein thus may allow for the detection of physical presence at a physical location and the creation of irrevocable evidence of that physical presence without the drawbacks of existing systems.

Having evidence of an individual's physical presence at a physical location may also improve systems that monitor for unauthorized activity such as unauthorized financial transactions. Such systems may detect a transaction and use the evidence of physical presence stored on the distributed ledger to determine whether the transaction is an authorized transaction or an unauthorized transaction. The distributed ledger may be maintained by the systems themselves and/or a distributed network system. Security may be further improved by only allowing access to a distributed ledger and/or distributed network system to particular IP addresses and/or subnets.

### Physical Presence Detection System

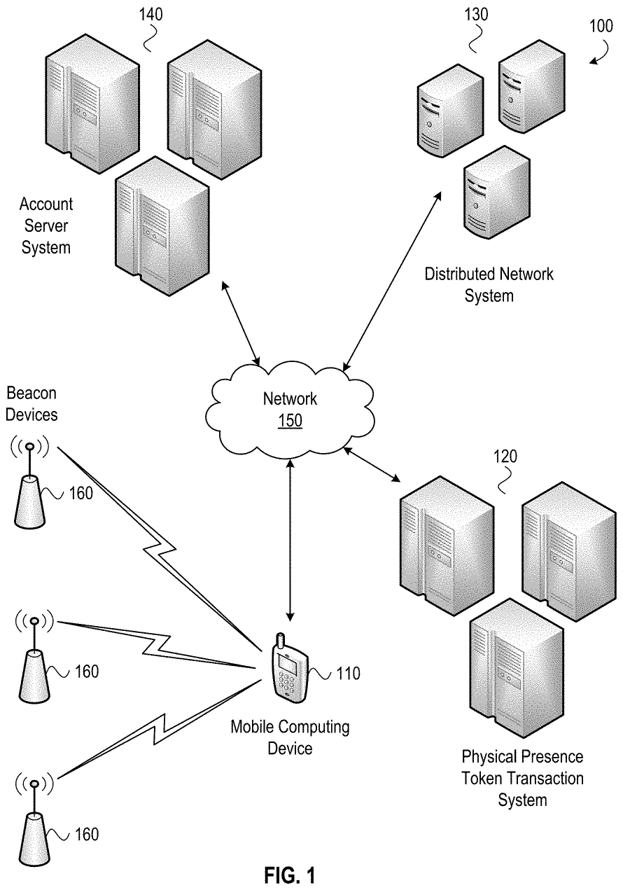

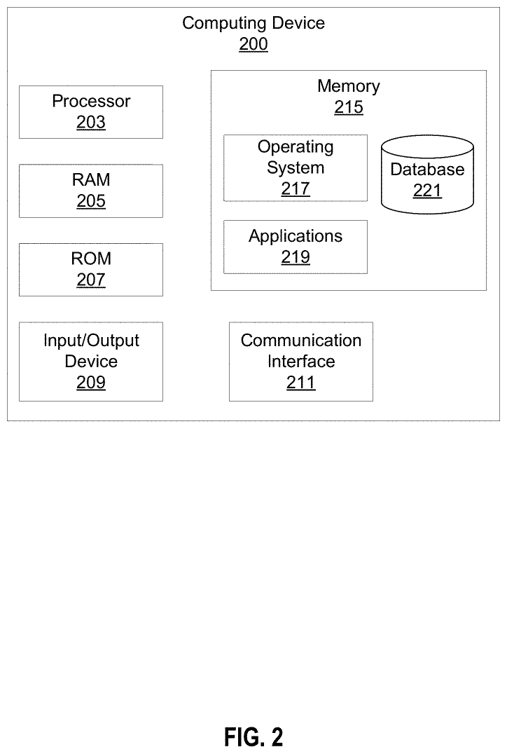

FIG. 1 shows an example of a physical presence detection system 100. The physical presence detection system 100 may include at least one mobile computing device 110, at least one physical presence token transaction system 120, at least one distributed network system 130, and at least one account server system 140 in communication via a network 150. The physical presence detection system 100 may also include one or more beacon devices 160. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, LTE, 5G NR, WiFi, Bluetooth, and NFC, is presumed, and the various computing devices described herein may be configured to communicate using any of these network protocols or technologies. Any of the devices and systems described herein may be implemented, in whole or in part, using one or more computing systems described with respect to FIG. 2.

The beacon devices 160 may transmit advertisements as described herein. A mobile computing device 110 may detect advertisements when in relatively close physical proximity to a beacon device 160 as described herein. The physical presence token transaction system 120 may generate an NFT with physical presence information and record a transaction including or otherwise indicating the NFT on a distributed ledger as described herein. A distributed network system 130 may store, modify, and/or execute one or more distributed ledgers as described herein. A distributed network system may be publicly accessible and/or have restricted access. An account server system 140 may store a variety of account data as described herein. Aspects of the systems shown by way of example in FIG. 1 may be incorporated into a single system which may perform any of the processes and/or store any data as described herein for the physical presence token transaction system 120, the distributed network system 130, and the account server system 140.

Some or all of the data described herein may be stored using one or more databases. Databases may include, but are not limited to relational databases, hierarchical databases, distributed databases, in-memory databases, flat file databases, XML databases, NoSQL databases, graph databases, and/or a combination thereof. The network 150 may include a local area network (LAN), a wide area network (WAN), a wireless telecommunications network, and/or any other communication network or combination thereof.

The data transferred to and from various computing devices in physical presence detection system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in file transfers to protect the integrity of the data such as, but not limited to, File Transfer Protocol (FTP), Secure File Transfer Protocol (SFTP), Pretty Good Privacy (PGP) encryption, the Advanced Encryption Standard (AES), and the like. In many embodiments, one or more web services may be implemented within the various computing devices. Web services may be accessed by authorized external devices and users to support input, extraction, and manipulation of data between the various computing devices in the data sharing system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML. Specialized hardware may be used to provide secure web services. Secure network appliances may include built-in features such as hardware-accelerated SSL and HTTPS, WS-Security, and/or firewalls. Such specialized hardware may be installed and configured in the physical presence detection system 100 in front of one or more computing devices such that any external devices may communicate directly with the specialized hardware.

As noted above, geofences are another example of proximity technology that may be used as an alternative to beacon devices to provide evidence of physical presence as described herein. A geofence may provide a virtual perimeter (e.g., a border, boundary, and the like) around a physical location. The physical location may thus be a physical area that is defined by the geofence. A location-based service provided by the geofence operator may monitor for location-aware mobile computing devices entering or exiting the geofence. Detecting a mobile device entering or exiting the physical location likewise may be used to provide evidence of physical presence as described herein. For example, detecting a mobile device entering or exiting a geofenced area may trigger the creation of an NFT with presence information as described. The location-based service and location-aware mobile computing device may employ, for example, Global Position System (GPS) technology to define and monitor one or more geofences.

### Beacon Devices

The beacon devices 160 in FIG. 1 may be used to provide evidence of physical presence as described herein. The beacon devices 160 may be located (e.g., installed, deployed, positioned, etc.) at a “real-world” physical location. The physical location may include one or more of a geographical location (e.g., specific geographic coordinates, a geographic region, a geographic sub-region, country, state, district, jurisdiction, city, town, municipality, zip code, zone, etc.), a point-of-interest (e.g., a residence, a business, retail store, a natural or man-made attraction, etc.), a space within a point-of-interest (e.g., floor, level, department, section, room, aisle, passageway, etc.), a boundary (e.g., a geographic boundary, jurisdictional boundary, etc.), and the like. More than one beacon device 160 may be located at a physical location. A beacon device located at a physical location may be described as being associated with that physical location.

The beacon devices 160 transmit (e.g., broadcast) signals that may be detected by computing devices (e.g., mobile computing device 110) within physical proximity of the beacon devices. The signals transmitted by the beacon devices 160 are used to provide evidence of physical presence as described herein. The signals transmitted by the beacon devices 160 may be referred to as advertisements. Suitable wireless technologies for transmitting the advertisements include, for example, WiFi, Bluetooth, Bluetooth Low Energy (BLE), ANT, Wireless USB, Zigbee, and other wireless communication standards of the IEEE 802 family. Detection of the advertisements may depend on the transmit power of the beacon devices. For example, a beacon device may be in a power class that transmits advertisements having a range of 1-100 centimeters (cm), 1-100 meters (m), or 1-10 kilometers (km), etc. In this regard, the beacon devices 160 may be configured to use “short-range” wireless technologies (e.g., less than 1 km) or “long range” wireless technologies (e.g., more than 1 km) to transmit an advertisement used to provide evidence of physical presence.

The advertisements transmitted by beacon devices 160 may be used to provide evidence of physical presence. The advertisements may include a variety of information that indicates one or more physical locations of the beacon devices 160. The advertisements may indicate a physical location in various ways. The advertisements may include or otherwise indicate, for example, specific geographic coordinates (e.g., latitude, longitude) provided by a GPS, a specific address of the physical location, a specific name of the physical location, a description of the physical location (e.g., “13^{th} floor,” “Room 237,” “Store No. 1138,” “Luxury Department,” etc.), and the like. The advertisements may additionally or alternatively include information that can be used to resolve the identity of a physical location and/or a subdivision of the physical location. Such information may include, for example, one or more identifiers such as a universally unique identifier (UUID), a category identifier, a classification identifier, and the like. The beacon devices 160 may be configured to use one or more beacon protocols to format and/or configure the transmitted signals. Examples of suitable beacon standards include iBeacon from Apple Inc. and Eddystone from Google Inc. Similar to the beacon advertisements, the location-based service of a geofence operator may provide the same or similar types of information that indicate or characterize a physical location (e.g., an area defined by a geofence).

The beacon devices 160 may be configured to transmit the advertisements at regular or irregular intervals. The intervals may be on the scale of nanoseconds (ns), milliseconds (ms), seconds (s), and the like. The beacon devices may be configured to activate a power saving mode (e.g., a sleep mode) between intervals. In this regard, a beacon device may be configured to sleep during some period of time (e.g., x-y ns, ms, s, etc.), wake up after the sleep period, transmit an advertisement, go back to sleep, and repeat. A beacon device may additionally or alternatively be configured to transmit an advertisement based on (e.g., in response to) an external trigger. For example, a beacon device may be configured to listen for signals transmitted by another device (e.g., mobile computing device 110) and transmit an advertisement based on detecting a signal from that device.

The beacon devices 160 may be powered by an internal power source (e.g., an internal battery) or an external power source (e.g., an external battery, AC or DC power supply, etc.). In some examples, the beacon devices may also be configured to provide a reduced power consumption relative to other devices in a similar power class and/or having a similar wireless range. In this regard, beacon devices providing a reduced power consumption may be referred to as “low energy” beacon devices. As such, low energy beacon devices may be configured to use a low energy wireless communication standard for transmission of the signals used to provide evidence of physical presence. BLE is one example of a suitable low power wireless communication standard that may be used for low energy beacon devices.

### Mobile Computing Devices

The mobile computing device 110 may detect an advertisement transmitted by a beacon device 160 when in physical proximity of the beacon device. A mobile computing device 110 may be in physical proximity of a beacon device 160 when the mobile computing device is within wireless range of the advertisements transmitted by the beacon device. As such, a mobile computing device 110 may be described as being physically present at the physical location based on the mobile computing device detecting an advertisement transmitted by a beacon device 160. It will thus be appreciated that a mobile computing device 110 may be described as being physically present at the physical location even though the mobile computing device and a beacon device 160 are separated by some distance. For example, where a beacon device 160 has a wireless range of 1-100 cm, a mobile computing device 110 may be deemed to be physically present at the physical location associated with that beacon device when the mobile computing device is within 1-100 cm of the beacon device. As another example, where a beacon device 160 has a wireless range of 1-10 m, a mobile computing device 110 may be deemed to be physically present at the physical location associated with that beacon device when the mobile computing device is within 1-10 m of the beacon device. As noted above, the mobile computing device may also be a location-aware mobile computing device and configured for communication with a location-based service provided by a geofence operator.

The mobile computing device 110 may be configured to detect the advertisements transmitted by the beacon devices 160. Such configuration may be provided natively by the mobile computing device 110 itself, e.g., by the native hardware, firmware, and/or software (e.g., a native operating system). Additionally or alternatively, such configuration may be provided by a third-party module, program, application, service, etc., that is added to (e.g., installed at) the mobile computing device 110. For example, an application may be installed on the mobile computing device 110 that configures the mobile computing device to listen (e.g., using its wireless receiver or transceiver) for advertisements transmitted by a beacon device. A location-aware mobile computing device similarly may be configured for communication with a location-based service of a geofence operator via an installed mobile application or via native functionality of the mobile computing device itself.

Detecting an advertisement may cause the mobile computing device 110 (e.g., using an installed application) to initiate a process of recording, on a distributed ledger, an indication of physical presence at the physical location associated with the beacon device 160 that transmitted the advertisement. That indication may indicate the presence of the mobile computing device 110, a user of the mobile computing device, or both, at the physical location. Additionally or alternatively, the indication of physical presence may include information that can be used to resolve the identity of the mobile computing device, its user, or both. The process for recording an indication of physical presence on a distributed ledger may also be based on detecting that the mobile computing device has entered or exited a geofenced area. The indication may indicate the presence of the mobile computing device inside or outside the perimeter of the geofenced area and/or whether the mobile computing device entered or exited the geofenced area.

As described herein, evidence of physical presence is recorded on a distributed ledger by providing an NFT to a digital wallet of the mobile computing device's user. Sending the NFT to the digital wallet and recording that transaction on a distributed ledger may thus provide evidence of the user's presence at the physical location. The address of the digital wallet that is to receive the NFT may be obtained by prompting the user to login to the digital wallet. The user may be prompted to login to the digital wallet based on detecting the advertisement from the beacon. The mobile computing device 110 may include or otherwise provide access to a digital wallet manager. The digital wallet manager may be, for example, a digital wallet management application installed at the mobile computing device 110. The digital wallet manager may also be an access portal presented, for example, via a web browser. A successful login via the digital wallet manager may thus serve to authenticate the identity of the user of the mobile computing device. The digital wallet manager may thus provide the address of the digital wallet that is to receive the NFT based on a successful login. It thus will be appreciated that the mobile computing device's presence at the physical location may be extrapolated to the presence of its user at the physical location such that the user may also be deemed to be present. It will also be appreciated that the user of the mobile computing device 110 may be someone other than the owner of the mobile computing device. Accordingly, the user of the mobile computing device may be considered to be the individual in possession of the mobile computing device when the advertisement is detected. As noted, the identity of the mobile computing device's user is not necessarily discernable simply by virtue of detecting an advertisement from the beacon and determined using an authentication mechanism (e.g., a successful login to a digital wallet manager) as described. Additional authentication mechanisms are described below.

The mobile computing device 110 may also be configured to send, to the physical presence token transaction system 120, the physical presence information and the address of the digital wallet that is to receive the NFT. The mobile computing device 110 may send the physical presence information and digital wallet address via the same application that listens for the advertisements from the beacon devices. As described in further detail below, the physical presence detection system may generate the NFT and record on the distributed ledger the transaction that provides the NFT to the digital wallet. Additionally or alternatively, the mobile computing device 110 itself may be configured (e.g., via the installed application) to generate the NFT and record the transaction.

Where geofencing is used, the mobile computing device 110 may be configured, for example, to provide GPS information received via a GPS system to a location-based service provided by the geofence operator. Geofencing techniques may then be employed to detect the presence of the mobile computing device 110 within a geofenced area based on the GPS information provided. User authentication as described herein may be triggered upon detecting that a mobile computing device has entered or exited a geofenced area. In some examples, a combination of beacon advertisements, GPS information, and/or geofencing techniques may be employed to confirm a detected physical presence at a physical location. A mobile computing device, for example, may be configured to determine its location within a geofenced area based on detecting an advertisement from a beacon device and/or may be configured to initiate listening for beacon advertisement based on entering a geofenced area. A combination of beacon devices and geofences may also be used to provide evidence of physical presence at interior and exterior physical locations. For example, beacons devices may be used to provide evidence of physical presence at relatively more precise interior physical locations (e.g., store fronts, store aisles, proximity to point-of-sale devices, etc.), and geofences may be used to provide evidence of physical presence at relatively more general exterior physical locations (e.g., near buildings, parks, city limits, etc.). Other location-based services may be employed to provide active or passive location awareness at the mobile computing device 110.

### Physical Presence Token Transaction System

The physical presence token transaction system 120 may receive physical presence information and the address of digital wallet that is to receive the NFT as described herein. The physical presence token transaction system 120 may be configured to generate an NFT using the physical presence information received. In some examples, the NFT generated may include the physical presence information as it was received (i.e., “as is”) from the mobile computing device 110, the beacon device 160, or a location-based service provided by a geofence operator. In other examples, the physical presence token transaction system 120 may be configured to derive information that is to be included in the NFT. As noted above, for example, the physical presence information may include information that is used to resolve the physical location of the beacon device or geofenced area. As such, the physical presence token transaction system 120 may be configured to resolve the physical location using the physical presence information received from the mobile computing device. For example, if the physical presence information received includes geographic coordinates (e.g., GPS coordinates), then the physical presence token transaction system 120 may determine an identifier (e.g., a name, address, etc.) of a point-of-interest at that physical location. In another example, if the physical presence information includes an identifier for a point-of-interest, then the physical presence token transaction system 120 may determine additional details about that point-of-interest (e.g., geographic coordinates, address, etc.). As described herein, geofencing techniques may also be employed to determine (e.g., resolve) the physical location. The physical presence information may also include a date and/or time (e.g., a timestamp) that the mobile computing device 110 detected the advertisement from a beacon device 160 or entered/exited a geofenced area. The physical presence information received from the mobile computing device 110 and/or any physical presence information subsequently derived may be included in the NFT generated by the physical presence token transaction system 120. The physical presence token transaction system 120 may also be configured to obfuscate (e.g., encrypt) the physical presence information included in the NFT. In this regard, the physical presence token transaction system may likewise be configured to de-obfuscate (e.g., decrypt) physical presence information of an NFT provided to a digital wallet. The mobile computing device 110 likewise may be configured to provide the same or similar functionality described for the physical presence token transaction system 120.

The NFT may be generated, for example, according to the ERC-721 Non-Fungible Token Standard. Other standards for generating NFTs may additionally or alternatively be used such as, for example, the ERC-874 Weighted Non-Fungible Token Standard which allows a weight to be assigned to an NFT, the ERC-998 Composable Non-Fungible Token Standard which allows an NFT to own another NFT, the ERC-1238 Non-Transferable Non-Fungible Token Standard which allows for the accumulation of non-transferrable digital badges, the ERC-1155 Multi Token Standard that allows for combinations of fungible tokens, non-fungible tokens, and semi-fungible tokens. As described further herein, one or more fungible tokens may be generated and provided to the digital wallet based on detecting physical presence at a physical location. A fungible token may be generated, for example, the ERC-20 Token Standard. Other standards for generating fungible tokens may additionally or alternatively be used such as, for example, the ERC-1203 Multi-Class Token Standard which allows for fungible tokens within the same class that are non-fungible relative to other classes (e.g., a hybrid of a fungible and non-fungible token). Other standards that extend the ERC-20 and/or ERC-721 standards may also be employed. The NFT may also be generated using non-ERC token standards.

The physical presence token transaction system 120 may also be configured to record that an NFT having the presence information described herein has been provided to a digital wallet. In this regard, the physical presence token transaction system 120 may be configured to generate a transaction block to record on the distributed ledger. The transaction block may include the address of the digital wallet that is to receive the NFT having the presence information. In some examples, the transaction block may comprise the NFT itself such that the NFT can be described as residing (e.g., “living”) on the distributed ledger. In these examples, the NFT may be provided to the digital wallet by recording the transaction block having the NFT on the distributed ledger and sending the digital wallet an indication of the transaction block and/or an indication of the NFT included in the transaction block. An identifier (e.g., a universally unique identifier) may be used to indicate the transaction block and/or the NFT. The indication of the NFT may additionally or alternatively include a copy of the NFT that is sent to the digital wallet. The copy of the NFT may reside, for example, on a computing device as described herein (e.g., mobile computing device 110, a laptop, a tablet, a thumb drive, a hardware wallet, etc.) of the owner of the digital wallet. In other examples, the NFT may be provided to the digital wallet by sending the NFT itself to the digital wallet such that the NFT can be described as residing (e.g., “living”) off the distributed ledger. In these examples, the NFT sent to the digital wallet may be stored by a computing device as described herein (e.g., mobile computing device 110, a laptop, a tablet, a thumb drive, a hardware wallet, etc.) of the owner of the digital wallet. In these examples, the NFT may be accessed using, for example, a digital wallet manager (e.g., a digital wallet management application) at the mobile computing device. The transaction block recorded to the distributed ledger, in these examples, thus may include the address of the digital wallet and an indication of the NFT (e.g., an identifier) and/or a copy of the NFT sent to the digital wallet. The NFT provided to the digital wallet may be, for example, in the form of a badge than can be displayed or otherwise presented by the digital wallet via a digital wallet manager. The distributed ledger may be maintained by the physical presence token transaction system 120 itself and/or a distributed network system (e.g., distributed network system 130).

As described further herein, the physical presence token transaction system 120 may also be configured to record that a fungible token has been provided to the digital wallet. In this regard, the physical presence token transaction system 120 may be configured to generate a transaction block to record on the distributed ledger that includes the address of the digital wallet and a fungible token itself (or an indication thereof). As such, the fungible token likewise may reside on or off the distributed ledger (e.g., may be sent to and stored at a mobile computing device of an owner of the digital wallet).

### Distributed Network System

A distributed network system (e.g., distributed network system 130) may maintain the distributed ledger. In some examples, the distributed network system may be separate from the physical token transaction system 120 (e.g., provided and maintained by separate entities). In other examples, the distributed network system 130 and the physical token transaction system 120 may be sub-systems of a larger system provided and maintained by a single entity. As such, a distributed network system may be publicly accessible and/or have restricted access. Access to a distributed network system may be limited to particular users, devices, services, and/or systems. A distributed network system may include a set of nodes. The nodes may operate independently and/or may be operated by one or more server systems. A distributed network system may include nodes operated via a public network (e.g. the Internet).

The distributed network system may maintain one or more distributed ledgers. A distributed ledger may be associated with a specific entity such that the distributed ledger is only accessible by a user, device, service, and/or system associated with that entity. In this regard, a distributed network system may maintain a first private distributed ledger that is accessible to only a first entity and a second private distributed ledger that is accessible to only a second entity. Access control mechanisms may thus be employed to record transaction blocks to a distributed ledger and/or access transaction information recorded on a distributed ledger. A distributed network system may maintain multiple public entities accessible to multiple entities. Various systems (e.g., account server system 140) may access a distributed ledger maintained by a distributed network system (e.g., distributed network system 130).

### Account Server Systems

An account server system (e.g., account server system 140) may access a distributed ledger. An account server system may maintain one or more accounts. The accounts may be associated with individuals having digital wallets used to manage transactions via a distributed ledger. In some examples, the accounts may be financial in nature. For example, an account server system may maintain one or more banking accounts (e.g., checking accounts, credit accounts, debit accounts, investment accounts, etc.). In other examples the accounts may be non-financial in nature. For example, an account server system may maintain one or more of user profile accounts (e.g., to access a computing system, a controlled access area, etc.), online accounts (e.g., email accounts, social media accounts, etc.). An account server system thus may be configured to maintain transaction records for transactions associated with such accounts. The associated transactions may likewise be financial or non-financial in nature. For example, an account server system may maintain financial transactions associated with a financial account (e.g., deposits, withdrawals, purchases, etc.). An account server system may maintain non-financial transactions associated with a non-financial account (e.g., logins, ingress and/or egress to access controlled areas, etc.). Accordingly, an account server system may be maintained by a financial institution, government agency, public or private enterprise (e.g., a business), organization, and the like.

An account server system may be configured to associate a digital wallet with an account. An account server system may receive the address of the digital wallet from, for example, a computing device as described herein that is associated with an owner of the account (e.g., mobile computing device 110, a laptop, thumb drive, hardware wallet, etc.). An account server system may thus associate the account with the digital wallet by storing the digital wallet's address with the account (e.g., as account information). In this way, an account server system may monitor transactions on the account and determine whether such transactions are authorized or unauthorized using the distributed ledger that indicates any NFTs with presence information that have been sent to the digital wallet. A digital wallet may be associated with an account temporarily (e.g., only for the duration of time needed to authenticate an owner of the digital wallet when providing the digital wallet with an NFT having presence information) or persistently.

An account server system may be configured to use a distributed ledger to determine whether the transaction is an authorized transaction or an unauthorized transaction. In the context of financial transactions, for example, a financial transaction may be an authorized financial transaction based on an owner of the account (or person associated therewith) performs or otherwise approves the financial transaction and may be an unauthorized financial transaction when the owner (or associated individual) does not perform or does not otherwise approve the financial transaction (e.g., if financial account information has been misappropriated). Authorized and unauthorized transactions will thus be appreciated for other contexts, for example, where access credentials are used to obtain access to, e.g., a computing system or controlled access area. An account server system may be configured to monitor use of such credentials associated with those access transactions to determine whether such access was authorized or unauthorized (e.g., if access credentials have been misappropriated).

As described further herein, an account server system may determine whether a transaction associated with an account is authorized or unauthorized by comparing a physical location of the transaction to any NFTs with presence information that have been provided to the digital wallet of an individual associated with the account. In this regard, an account server system may be configured to determine the physical location of a transaction. The physical location of the transaction may be any of the physical locations at or within which a beacon device (e.g., beacon device 160) and/or a geofenced area is located as described herein. An account server system may also be configured to obtain, from a distributed ledger, presence information associated with a digital wallet. Obtaining presence information associated with a digital wallet may include, for example, obtaining particular presence information included in an NFT that has been provided to the digital wallet and/or obtaining one or more NFTs with presence information (or indications thereof) that have been sent to the digital wallet. An account server system may obtain presence information by, for example, performing a query, search, or lookup at the distributed ledger, using one or more application programming interfaces (APIs), remote procedure calls (RPCs), or inter-process communications (IPCs) that provide access to the distributed ledger, using one or more session-based communications, using one or more “smart contracts” residing on the distributed ledger, and the like. An account server system may be configured to obtain the physical location of a transaction in a similar fashion, e.g., using one or more of a query, search, lookup, API, RPC, IPC, communication session, “smart contract,” and the like.

An account server system may be configured to obtain presence information associated with a digital wallet in various ways. For example, an account server system may be configured to request any NFTs with presence information that have been provided to a digital wallet by specifying (e.g., in a request) the address of the digital wallet whereby the account server system receives any relevant NFTs in response. An account server system thus also may be configured to extract presence information from a received NFT. Additionally or alternatively, an account server system may receive one or more identifiers for any NFTs that have been sent to a digital wallet (e.g., by specifying a digital wallet address) and receive a list of the relevant NFTs in response (e.g., a list of NFT unique identifiers). As such, an account server system may be configured to request the presence information itself by specifying one or more particular NFTs (e.g., using one or more of the NFT unique identifiers) whereby the account server system receives any relevant presence information in response.

An account server system may also be configured to determine whether a physical location were a transaction occurred is the same as a physical location where a mobile computing device (e.g., mobile computing device 110) was detected, e.g., using an advertisement from a beacon device (e.g., beacon device 160), a geofenced area, or other location-based service. An account server system may be configured to determine that the physical locations are the same based on having matching identifiers or some other matching descriptors (e.g., where the geographical coordinates, address, name, etc. are the same). An account server system may be configured to determine that the physical locations are the same based on them being within some threshold distance of each other (e.g., within x number of feet/meters, yards, miles/kilometers, etc.). An account server system may be configured to determine that the physical locations are the same based on respective indications of the physical locations resolving to the same identifier and/or descriptor of the physical locations. Physical locations determined to be the same may be described as corresponding physical locations. An account server system may further be configured to compare the date and time a transaction occurred to the date and time indicated in the presence information in order to determine whether the transaction was contemporaneous with the detected physical presence at the physical location. A transaction may be contemporaneous with a detected physical presence based on being within some threshold amount of time of the detected physical presence (e.g., within x number of seconds, minutes, hours, days, etc.).

An account server system may also be configured to notify an individual associated with an account whether a transaction is determined to be authorized or unauthorized. Any suitable means for notifying the individual may be employed (e.g., a telephone call, a text message, an email, a push notification, and the like). The notification may be sent automatically based on determining that the transaction is unauthorized or based on determining that the transaction is authorized. The account server system may be configured to determine whether a transaction is authorized or unauthorized based on detecting the transaction (e.g., as soon as the transaction occurs). The account server system may be configured to determine whether one or more transactions (e.g., a batch of transactions) are authorized or unauthorized as part of a regularly or irregularly scheduled process. The account server system may be configured to determine whether one or more transactions are authorized or unauthorized on-demand in response to a request (e.g., a received instruction, command, etc.).

### Computing Devices

Turning now to FIG. 2, a computing device 200 that may be used with one or more of the computational systems is described. The computing device 200 may include a processor 203 for controlling overall operation of the computing device 200 and its associated components, including RAM 205, ROM 207, input/output device 209, communication interface 211, and/or memory 215. A data bus may interconnect processor(s) 203, RAM 205, ROM 207, memory 215, I/O device 209, and/or communication interface 211. In some embodiments, computing device 200 may represent, be incorporated in, and/or include various devices such as a desktop computer, a computer server, a network appliance, an information appliance, a video game console, a media player, a microconsole, a mobile computing device, such as a laptop computer, a tablet computer, a smart phone, a smart watch, a thumb drive, any other types of mobile computing devices, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Software may be stored within memory 215 to provide instructions to processor 203 allowing computing device 200 to perform various actions. Memory 215 may store software used by the computing device 200, such as an operating system 217, application programs 219, and/or an associated internal database 221. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other non-transitory computer-readable storage medium that may be used to store the desired information and that may be accessed by processor 203.

Communication interface 211 may include one or more transceivers, digital signal processors, and/or additional circuitry and software for communicating via any network, wired or wireless, using any protocol as described herein.

Processor 203 may include a single central processing unit (CPU), which may be a single-core or multi-core processor, or may include multiple CPUs. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches including, but not limited to, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the claimed subject matter.

### Recording Irrevocable Evidence of Physical Presence on a Distributed Ledger

Physical presence detection systems may use a distributed ledger to record irrevocable evidence of a detected physical presence at a physical location. The distributed ledger may record transactions that send NFTs to digital wallets with presence information corresponding to a detected physical presence at a physical location. The evidence of physical presence may be deemed irrevocable by virtue of the distributed ledger's replication of identical copies of the distributed ledger across multiple nodes (e.g., of a distributed network system) and the consensus-based nature of validating and recording transactions to the distributed ledger. The distributed ledger may be, for example, a blockchain whereby the transactions are recorded as blocks on the blockchain. It will be appreciated that the recognition of the evidence of physical presence as irrevocable presumes at least one node maintains an accurate copy of the distributed ledger.

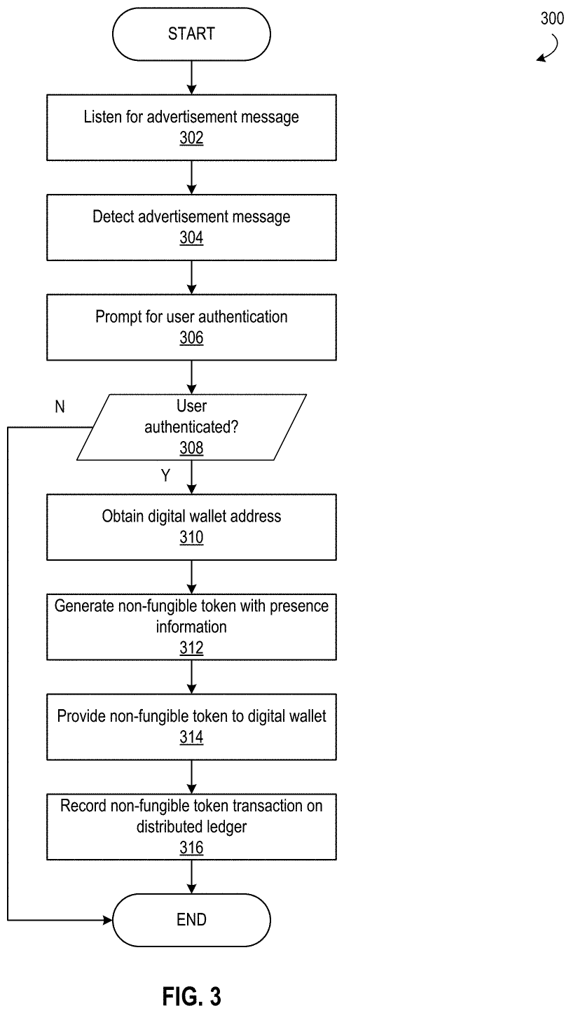

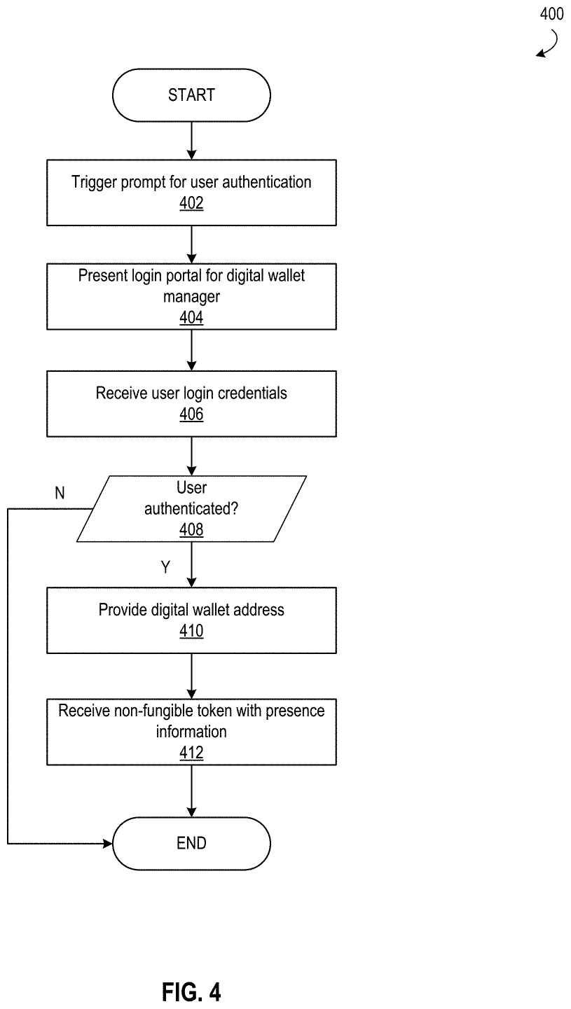

FIG. 3 shows a flow chart of an example process 300 for detecting the presence of a mobile computing device at a physical location and recording the detected physical presence on a distributed ledger. Some or all of the steps may be performed using one or more computing devices as described herein. At step 302, a mobile computing device may listen for an advertisement as described herein. The mobile computing device may be configured to listen for advertisements by way of a mobile application installed and executing at the mobile computing device. The mobile application may execute in the background of the mobile computing device (e.g., as a “background process”). At step 304, the mobile computing device may detect an advertisement as described herein. The advertisement may be detected by the mobile application installed at and executing at the mobile computing device. The advertisement may be transmitted by a beacon device as described herein. Detecting the advertisement may trigger one or more actions at the mobile computing device. The actions triggered at the mobile computing device may be initiated by the mobile application that detected the advertisement. Triggered actions may include prompting a user for user authentication at the mobile computing device as described herein. As described herein, other location-based services (e.g., geofencing) may be employed to detect the physical presence of the mobile computing device at a physical location. Such other location based services may likewise trigger one or more actions at the mobile computing device (e.g., based on detecting the mobile computing device has entered a geofenced area) such as prompting for user-authentication. At step 306, a user of the mobile computing device may be prompted to perform a user authentication procedure. Authenticating the identity of the user is discussed further below with reference to FIG. 4. User authentication allows the identity of the user of the mobile computing device to be associated with the detected physical presence, e.g., the physical location, the date the physical presence was detected, the time the physical presence was detected, etc. At step 308, successful or unsuccessful user authentication may be determined. If the user is not successfully authenticated (“N”), then the process may end, and the detected advertisement may be disregarded (e.g., dismissed, ignored, deleted, etc.). If, however, the user is successfully authenticated (“Y”), then at step 310 an address of a digital wallet associated with the authenticated user may be obtained as described herein. At step 312, an NFT with presence information may be generated as described herein. For example, the generated NFT may include indication of the physical location associated with the beacon device that transmitted the advertisement, the date the advertisement was detected, and the time the advertisement was detected. At step 314, the NFT may be provided to the digital wallet using the digital wallet address obtained as described herein. At step 316, an indication of the NFT provided to the digital wallet may be recorded on a distributed ledger as described herein. The NFT provided to the digital wallet and the corresponding transaction recorded to the distributed ledger thus advantageously provide an immutable record that the individual was present at the physical location at the date and/or time indicated in the NFT for purpose of verification, security, monitoring, and the like.

### Authenticating an Owner of a Digital Wallet

FIG. 4 shows a flow chart of an example process 400 for authenticating an owner of a digital wallet. At step 402, a prompt for user authentication may be triggered as described herein. For example, the prompt for user authentication may be triggered by a mobile application installed at the mobile computing device based on the mobile application detecting an advertisement from a beacon device. At step 404, a login portal for a digital wallet manager may be presented (e.g., displayed) at the mobile computing device as described herein. For example, the login portal may be presented by a digital wallet management application installed at the mobile computing device or by a web browser that provides access to a digital wallet via a web interface. At step 406, user login credentials may be received (e.g., a username/password combination; multi-factor authentication; biometric authentication such as face recognition, fingerprint recognition, touch gesture recognition (e.g., swipes, presses, etc.), micro-movement recognition (e.g., gait pattern, etc.); and the like). At step 408, successful or unsuccessful user authentication may be determined. If the user is not successfully authenticated (“N”), then the process may end as described above with reference to FIG. 3. If, however, the user is successfully authenticated (“Y”), then at step 410 the digital wallet address may be provided as described herein. For example, the digital wallet manager may provide the digital wallet address to the mobile application that detected the advertisement which may then relay the digital wallet address to a physical presence token transaction system along with the presence information for generation of the NFT. In another example, the digital wallet manager itself may provide the digital wallet address to a physical presence token transaction system with the physical presence information being provided separately (e.g., by the mobile application that detected the advertisement). At step 412, the digital wallet associated with the authenticated user may be provided with an NFT having physical presence information indicating that the user's physical presence was detected at the physical location associated with the beacon device that transmitted the detected advertisement as described herein. Presenting a login portal to a digital wallet manager is one example of a means for obtaining an address of the digital wallet. More generally, in accordance with aspects described herein, a system may cause a mobile computing device to output (e.g., on a display) a request to grant a mobile application access to the digital wallet manager and, based on the mobile application being granted such access, receive the address of the digital wallet.

Additional and alternative approaches may be employed to authenticating the user. For example, the mobile computing device may be configured (e.g., via one of its installed mobile applications) to store an indication of successful authentication of the user. This indication of successful user authentication may be used to provide the digital wallet address for subsequent detections of advertisements from other beacon devices at other physical locations. In this way, a user may need to successfully authenticate only once such that the digital wallet address is provided automatically based on subsequently detected advertisements. The digital wallet address may also be provided semi-automatically based on the user's approval. For example, detecting an advertisement may trigger presentation (e.g., display) of a notification (e.g., a pop-up notification) at the mobile computing device with options to, e.g., “approve” or “deny” providing the digital wallet address based on detecting the advertisement. Storing an indication of successful authentication and automatically or semi-automatically providing the digital wallet address may be user-configurable settings at the mobile computing device.

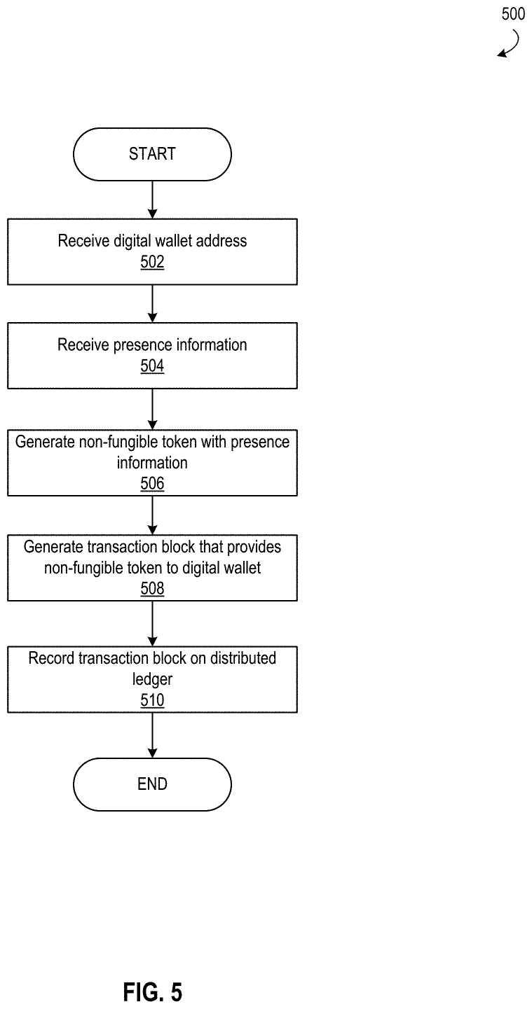

Another approach to user authentication may involve exchanging a nonce NFT with a digital wallet. For example, based on detecting an advertisement a prompt may be presented (e.g., displayed) requesting a digital wallet address that should receive the NFT having the presence information. A user may provide (e.g., input) the digital wallet address for the preferred digital wallet. Alternatively, a digital wallet address may be automatically provided based on detecting an advertisement (e.g., by a digital wallet manager at the mobile computing device). The digital wallet address may be received at a physical presence token transaction system (e.g., via a digital wallet manager or another application installed at the mobile computing device). The physical token transaction system may then provide a nonce NFT to the digital wallet using the received digital wallet address. The user associated with the digital wallet may then return the nonce NFT to the physical token transaction system. The user associated with the digital wallet may thus be authenticated given the access control mechanisms used to secure access to the digital wallet. In other words, because only the owner of the digital wallet is presumed to have access to the digital wallet, returning the nonce NFT provided to the digital wallet can serve as an indication of successful user authentication of the digital wallet. In turn, the NFT having presence information may be provided to that digital wallet as described herein to provide evidence of the authenticated user's physical presence at the physical location associated with the beacon device that transmitted the detected advertisement. One or more example steps shown in FIG. 5 may be used to determine whether other types of transactions are authorized or unauthorized transactions as described herein.

### Providing Evidence of Physical Presence Using a Distributed Ledger

FIG. 5 shows a flow chart of an example process 500 for providing evidence of physical presence using a distributed ledger. The example steps shown in FIG. 5 may be performed, for example, by a physical token transaction system as described herein. At step 502, a digital wallet address may be received as described herein. At step 504, presence information may be received as described herein. The digital wallet address and presence information may be received, e.g., collectively in a single message or separately in multiple messages. At step 506, an NFT having presence information may be generated as described herein. At step 508, a transaction block that provides (e.g., sends) the NFT to the digital wallet may be generated as described herein. At step 510, the transaction block may be recorded to a distributed ledger as described herein. Recording the transaction block on the distributed ledger may be subject to a consensus check by the distributed network system (e.g., distributed network system 130). One or more of the steps shown in FIG. 5 also may be performed by another computing device and/or system, e.g., a mobile computing device or an account server system.

### Detecting Unauthorized Financial Transactions Using a Distributed Ledger

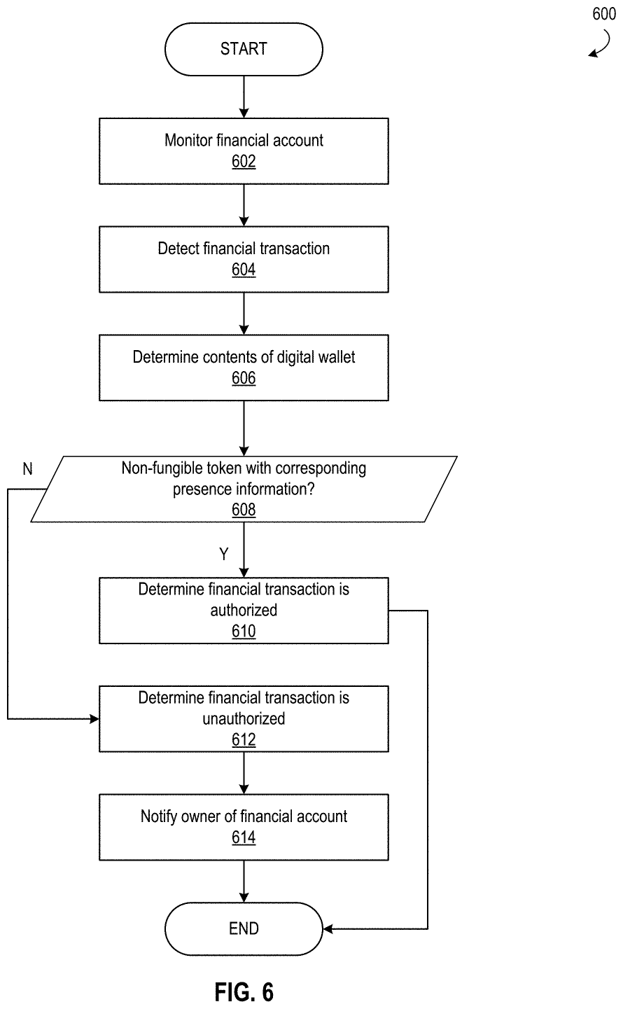

FIG. 6 shows a flow chart of an example process 600 for detecting an unauthorized financial transaction using a distributed ledger. One or more of the example steps shown in FIG. 6 also may be performed to determine that a financial transaction is an authorized transaction using a distributed ledger. The example steps shown in FIG. 6 may be performed, for example, by an account server system as described herein. At step 602, a financial account may be monitored as described herein. Monitoring the financial account may include determining whether a new financial transaction has occurred. At step 604, a financial transaction may be detected as described herein. Detecting the financial transaction may include determining information about the financial transaction including, for example, a physical location where the transaction occurred, a date the transaction occurred, and a time the transaction occurred. At step 606, the contents of a digital wallet of an individual associated with the financial account may be determined as described herein. Per above, the digital wallet of an individual associated with the financial account may be determined by authenticating the individual. At step 608, the contents of the digital wallet may be evaluated to determine whether those contents include any NFTs with presence information that corresponds to the information for the financial transaction as described herein. If the contents of the digital wallet include an NFT with presence information corresponding to information for the financial transaction (“Y”), then at step 610 the financial transaction may be identified as an authorized transaction. If, however, the contents of the digital wallet do not include any NFTs or do not include any NFTs with physical presence information corresponding to the information for the financial transaction (“N”), then at step 612 the financial transaction may be identified as an unauthorized transaction. Determining a financial transaction is an unauthorized financial transaction may include determining that the financial transaction is potentially (e.g., likely) unauthorized. For example, determine whether a financial transaction is potentially unauthorized may include scoring the financial transaction (e.g., determining a fraud score). Scoring the financial transaction may include evaluating a variety of factors associated with the financial account and/or financial transaction (e.g., transaction history, amount thresholds, etc.), one of which may be whether the digital wallet has received an NFT having presence information corresponding to the information for the financial transaction. As such, a financial transaction may be identified as an authorized or unauthorized financial transaction based on whether a score for the transaction satisfies a score threshold (e.g., does or does not meet or exceed the score threshold). In the context of financial transactions, the score may be a fraud score and the score threshold may be a fraud score threshold. Per above, an NFT's physical presence information may correspond to the information for a financial transaction when, for example, the physical locations of each are the same or substantially the same (e.g., within a threshold distance of each other), the dates of each are the same, and the times of each are the same of substantially the same (e.g., within a threshold amount of time of each other). At step 614, the individual may be notified of the unauthorized financial transaction as described herein. Notifying the individual of the unauthorized financial transaction may allow the individual to take remedial action, e.g., dispute the transaction, lock the financial account, and the like. Other remedial actions may be performed based on determining the detected financial transaction is an unauthorized transaction. For example, a hold may be placed on the financial transaction, the financial transaction may be cancelled, the financial account may be frozen, and the like. An individual may also be notified that a detected financial transaction has been identified as an authorized transaction.

### Additional Applications and Use Cases

Using NFTs and a distributed ledger to provide irrevocable evidence of physical presence at a physical location may have other applications beyond detecting unauthorized financial transactions as discussed above. Additionally or alternatively, for example, other digital assets beyond NFTs may be provided based on detecting an advertisement from a beacon device at a physical location. Such other digital assets include, for example, fungible tokens, cryptocurrencies, and the like. In some particular example use cases, a digital asset may be provided to a digital wallet as a reward for the individual being present a physical location such as, e.g., a video game asset that is provided based on the individual visiting a physical location identified by a video game, a badge recognizing that the individual accomplished a physical activity (e.g., a physical challenge, a physical competition), a coupon for visiting a retail store, an insignia that the individual has visited certain unique locations around the world (e.g., geographic locations—Antarctica, the North Pole, the top of Mount Kilamanjaro; venues—United States baseball parks, the top of the St. Louis Arch, the Tower of London, the Sydney Opera House; etc.). and the like. Coupons provided as a reward for visiting a retail location may be provided as tokens (fungible or non-fungible) to the digital wallet. Such tokens may include expiration information indicating that the coupon expires (e.g., must be redeemed) within some threshold amount of time (e.g., 30-60 minutes or some other x number of minutes) after detecting the individual's presence at the retail location. Accordingly, the mobile application that listens for and detects advertisements from beacon devices may be a retail mobile application provided by the retail entity. A retail mobile application may be configured to listen for and detect advertisements only from beacon devices associated with (e.g., deployed by, installed at, etc.) the retail entity. As such, a mobile computing device may include multiple retail mobile applications each being respectively configured to listen for and detect advertisements only from beacon devices that are associated with their respective retail entities. More generally, a mobile application may be configured to listen for and detect advertisement only from beacon devices associated with a particular entity (e.g., institution, organization, enterprise, etc.). In another example use case, the digital wallet may function as a passport whereby the NFTs having the presence information may indicate that the individual was physically present at a particular border crossing at a certain date and time thus serving as a permanent record of the individual's travels. The NFTs with physical presence information similarly may be used to provide a permanent record of an individual's movements through a particular area (e.g., through a building or other structure having various access controlled areas with beacon devices respectively positioned in those areas). Further, multiple NFTs may be provided to a digital wallet in an iterative fashion based on detecting multiple advertisements iteratively transmitted by a beacon device at a physical location in order to provide an indication of how long the individual was present at a physical location (e.g., by determining the duration between the first and last NFTs provided). The duration of an individual's presence may be included in the presence information of an NFT or otherwise derivable from the NFTs that are provided to the individual's digital wallet. In one example use case, using NFTs and a distributed ledger to provide irrevocable evidence of physical presence at a physical location may be used to enhance credentials (e.g., an academic degree, certificate, diploma, etc.) awarded by a credential-granting institution (e.g., college, university, other educational and/or training institutions, etc.) To combat the perceived increase in fraudulent credentials, some credential-granting institutions have used NFTs to issue credentials that can be verified and authenticated via a distributed ledger. Such credentials, however, might not indicate the extent to which the individual was physically present at any locations associated with the course work for those credentials (e.g., during scheduled class times, lab times, etc.). By using NFTs having physical presence information as described herein, credentials issued via NFTs may be enhanced by providing an attendance record for the user indicating how often the user was present for the required course work (e.g., “perfect” attendance, consistently, occasionally, rarely, etc.). Such attendance records may be included in the NFT for the credential or provided as one or more separate NFTs.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A computer-implemented method comprising:
obtaining, by a server system and based on a mobile computing device receiving a message from a beacon device located at a physical location, an address of a digital wallet;
recording, by the server system and on a distributed ledger, a transaction block comprising indication of:
the address of the digital wallet; and
a non-fungible token comprising presence information that indicates at least one of the physical location, a date the mobile computing device received the message, and a time the mobile computing device received the message;
detecting a plurality of financial transactions associated with a financial account of an owner of the digital wallet;
determining, by the server system, that a first financial transaction of the plurality of financial transactions is an authorized financial transaction based on the non-fungible token having presence information that corresponds to the first financial transaction;
determining, by the server system, that a second financial transaction of the plurality of financial transactions is an unauthorized financial transaction based on the digital wallet comprising no non-fungible token having presence information that corresponds to the second financial transaction; and
sending, by the server system and to at least the owner of the digital wallet, an indication of the unauthorized financial transaction.

2. The computer-implemented method of claim 1, further comprising sending, to the digital wallet, an indication of the non-fungible token, wherein the indication of the non-fungible token comprises at least one of:
a copy of the non-fungible token; or
an identifier of the transaction block recorded on the distributed ledger.

3. The computer-implemented method of claim 1, wherein the determining that the first financial transaction is an authorized financial transaction is based on:
a location of the first financial transaction being within a threshold distance of the physical location indicated by the presence information of the non-fungible token;
a date of the first financial transaction matching the date indicated by the presence information of the non-fungible token; and
a time of the first financial transaction being within a threshold amount of time of the time indicated by the presence information of the non-fungible token.

4. The computer-implemented method of claim 1, wherein:
the determining that the second financial transaction is an unauthorized financial transaction comprises determining, for the second financial transaction and based on presence information of at least one non-fungible token sent to the digital wallet, a fraud score; and
the sending the indication of the unauthorized financial transaction comprises sending the indication based on the fraud score satisfying a fraud score threshold.

5. The computer-implemented method of claim 1, further comprising associating, by the server system and based on successful authentication of the owner of the digital wallet, the address of the digital wallet with the financial account of the owner.

6. The computer-implemented method of claim 1, further comprising authenticating, by the server system, the owner of the digital wallet, wherein the authenticating comprises:
providing, to the digital wallet, a second non-fungible token; and
receiving, after the providing the second non-fungible token and from the digital wallet, the second non-fungible token.

7. The computer-implemented method of claim 1, wherein the obtaining the address of the digital wallet comprises:
causing output, at the mobile computing device, of a request to login to a digital wallet manager that is configured to manage access to the digital wallet; and
receiving, by the server system and based on the login being successful, the address of the digital wallet.

8. The computer-implemented method of claim 1, wherein the obtaining comprises automatically receiving, from a digital wallet manager that is configured to manage access to the digital wallet and based on the mobile computing device receiving the message from the beacon device, the address of the digital wallet.

9. The computer-implemented method of claim 1, further comprising recording, by the server system and based on the mobile computing device receiving the message from the beacon device, a second transaction block comprising:
the address of the digital wallet; and
a fungible token.

10. The computer-implemented method of claim 9, wherein the second transaction block further comprises expiration information indicating that the fungible token expires an amount of time after the recording the second transaction block on the distributed ledger.

11. A computing system comprising:
one or more processors; and
memory storing instructions that, when executed by the one or more processors, cause the computing system to:
detect, via a mobile application installed on a mobile computing device, a message transmitted by a beacon device located at a physical location;
cause output, on a display of the mobile computing device and based on detecting the message, of a request to grant the mobile application access to a digital wallet manager that is configured to manage access to a digital wallet;
receive, via the mobile application and based on being granted access to the digital wallet manager, an address of the digital wallet;
record, on a distributed ledger, a transaction block comprising indication of:
the address of the digital wallet; and
a non-fungible token comprising presence information that indicates at least one of the physical location, a date the message was received, and a time the message was received;
detect a plurality of financial transactions associated with a financial account of an owner of the digital wallet;
determine that a first financial transaction of the plurality of financial transactions is an authorized financial transaction based on the non-fungible token having presence information that corresponds to the first financial transaction;
determine that a second financial transaction of the plurality of financial transactions is an unauthorized financial transaction based on the digital wallet comprising no non-fungible token having presence information that corresponds to the second financial transaction; and
send, to at least the mobile computing device, an indication of the unauthorized financial transaction.

12. The computing system of claim 11, wherein the instructions, when executed by the one or more processors, cause the computing system to send, to the digital wallet, an indication of the non-fungible token, wherein the indication of the non-fungible token comprises at least one of:
a copy of the non-fungible token; or
an identifier of the transaction block recorded on the distributed ledger.

13. The computing system of claim 11, wherein the instructions, when executed by the one or more processors, cause the computing system to determine the first financial transaction is an authorized financial transaction based on:
a location of the first financial transaction being within a threshold distance of the physical location indicated by the presence information of the non-fungible token
a date of the first financial transaction matching the date indicated by the presence information of the non-fungible token; and
a time of the first financial transaction being within a threshold amount of time of the time indicated by the presence information of the non-fungible token.

14. The computing system of claim 11, wherein the instructions, when executed by the one or more processors, cause the computing system to:
determine that the second financial transaction is an unauthorized financial transaction at least by:
determining, for the second financial transaction and based on presence information of at least one non-fungible token sent to the digital wallet, a fraud score; and
comparing the fraud score to a fraud score threshold; and
send the indication of the unauthorized financial transaction based on the fraud score satisfying the fraud score threshold.

15. The computing system of claim 11, wherein the instructions, when executed by the one or more processors, cause the computing system to record, based on detecting the message and on the distributed ledger, a second transaction block comprising:
the address of the digital wallet; and
a fungible token.

16. A non-transitory computer-readable storage medium comprising instructions that, when executed, cause a computing system to:
detect, via a mobile application installed on a mobile computing device, a message transmitted by a beacon device located at a physical location;
cause output, on a display of the mobile computing device and based on detecting the message, of a prompt to perform a login at a digital wallet management application that is installed at the mobile computing device and that is configured to manage access to a digital wallet;
receive, from the digital wallet management application via the mobile application and based on the login being successful, an address of the digital wallet;
authenticate an owner of the digital wallet;
associate, based on successful authentication of the owner of the digital wallet, the address of the digital wallet with a financial account of the owner of the digital wallet;
record, on a distributed ledger, a transaction block comprising indication of:
the address of the digital wallet; and
a non-fungible token comprising presence information that indicates at least one of the physical location, a date the message was received, and a time the message was received;
detect a plurality of financial transactions associated with a financial account of an owner of the digital wallet;
determine that a first financial transaction of the plurality of financial transactions is an authorized financial transaction based on the non-fungible token having presence information that corresponds to the first financial transaction;
determine that a second financial transaction of the plurality of financial transactions is an unauthorized financial transactions based on the digital wallet comprising no non-fungible token having presence information that corresponds to the second financial transaction; and
send, to at least the mobile computing device, an indication of the unauthorized financial transaction.

17. The non-transitory computer-readable storage medium of claim 16, wherein the instructions, when executed, cause the computing system to send, to the digital wallet, an indication of the non-fungible token, wherein the indication of the non-fungible token comprises at least one of:
a copy of the non-fungible token; or
an identifier of the transaction block recorded on the distributed ledger.

18. The non-transitory computer-readable storage medium of claim 16, wherein the instructions, when executed, cause the computing system to determine the first financial transaction is an authorized financial transaction based on:
a location of the first financial transaction being within a threshold distance of the physical location indicated by the presence information of the non-fungible token;
a date of the first financial transaction matching the date indicated by the presence information of the non-fungible token; and
a time of the first financial transaction being within a threshold amount of time of the time indicated by the presence information of the non-fungible token.

19. The non-transitory computer-readable storage medium of claim 16, wherein the instructions, when executed, further cause the computing system to:
determine that the second financial transaction is an unauthorized financial transaction at least by:
determining, for the second financial transaction and based on presence information of at least one non-fungible token sent to the digital wallet, a fraud score; and
compare the fraud score to a fraud score threshold; and
send the indication of the unauthorized financial transaction based on the fraud score satisfying the fraud score threshold.

20. The non-transitory computer-readable storage medium of claim 16, wherein the transaction block comprises the non-fungible token.
